(19) United States
(12) Patent Application Publication
(10) Pub. No.: US 2026/0019669 A1
(43) Pub. Date: Jan. 15, 2026

(54) TV Commercial Blocker

(71) Applicant: Nicholas Joseph Pittore, Napa, CA (US)

(72) Inventor: Nicholas Joseph Pittore, Napa, CA (US)

(21) Appl. No.: 19/205,214

(22) Filed: May 12, 2025

Related U.S. Application Data
(60) Provisional application No. 63/732,096, filed on Jul. 15, 2024.

(51) Int. Cl. H04N 21/454; H04N 21/422; H04N 21/4363

(52) U.S. Cl. CPC H04N 21/4542; H04N 21/42221; H04N 21/43635

(57) ABSTRACT

A device that allows the user to block television commercials by pressing a button on a remote controller. The device works by temporarily not transmitting the audio-visual signal, for a period of roughly 120 seconds, which is the length of a standard television commercial break, and then continuing to transmit the audio-visual signal after this time has elapsed.

### BACKGROUND OF THE INVENTION

This product pertains to the field of television and media products. Specifically, pertaining to blocking an HDMI signal during commercial breaks, and transmitting the signal during the rest of the broadcast/stream.

Television commercials can be annoying and obnoxious and most viewers do not want to watch them, if they can avoid it. There is currently no device made to block them out by blocking the actual local HDMI electrical signal. There are currently devices to switch between different HDMI signals or manually turn signals on or off, but none of these devices are suited for, or targeted toward, blocking the signal during a commercial break. None of them have an automated, timed period, during which they block a 2 minute commercial break and then automatically transmit the signal after this period has elapsed. They are merely intended to manually switch between inputs or turn inputs on and off, but they do not address the specific issue of television commercials, and providing the user with a way of blocking them, to have a more enjoyable viewing experience.

There are some subscription based media streaming services out there that automatically show a different screen during commercial breaks and do not show the commercials. But that is different in that it is the media providing service that is not showing commercials. So the user is not actually able to block anything, they are just watching content that does not have commercials in it. This device, on the other hand, can be used on any type of media content and is a tangible physical device that actually physically blocks the electrical HDMI signal to the television. It can block commercials whenever the user wants at the press of a button and has nothing to do with the subscription or content provider. It can be used with any type of media content, regardless of the provider, whenever the user desires.

### SUMMARY OF THE INVENTION

This invention will allow the user to block television commercials whenever they desire. It will block the signal going from an audio-visual source to the television and therefore make the screen go blank and the sound turn off for a set amount of time whenever the user presses a button on a remote controller. The amount of time will correspond to the standard length of television commercial breaks (120 seconds). Then, after the commercial break duration has elapsed, the device will allow the signal to pass through again, which will cause the television picture and sound to turn back on right before the commercial break ends. The timed block period will be slightly less that 120 seconds so that the stream comes back on just before the commercial break ends, and also to account for delayed user reaction time when the commercial break starts.

The device will give the user an automated way to block only the commercials without missing any of the program that they are watching, so that they can avoid watching commercial breaks if they choose. It will have 2 HDMI ports; one for the input signal from the AV source, and the other to output the signal to the television. It will come with a wireless remote controller that has two buttons; one to initiate blocking the commercial break duration, and the other to cancel/abort the blocked period and resume watching immediately, if desired.

### BRIEF DESCRIPTION OF DRAWINGS

The following is a brief description of each figure in the drawings:

FIG. 1 is an isometric side view sketch of the commercial blocker device,

FIG. 2 is an isometric top view sketch of the commercial blocker device,

FIG. 3 is an isometric side view sketch of the commercial blocker device,

FIG. 4 is an isometric side view sketch of the remote controller for the commercial blocker device,

FIG. 5 is an isometric top view sketch of the remote controller for the commercial blocker device,

FIG. 6 is an isometric side view sketch of the remote controller for the commercial blocker device,

FIG. 7 is a circuit schematic for the commercial blocker device,

FIG. 8 is a circuit schematic for the remote controller for the commercial blocker device.

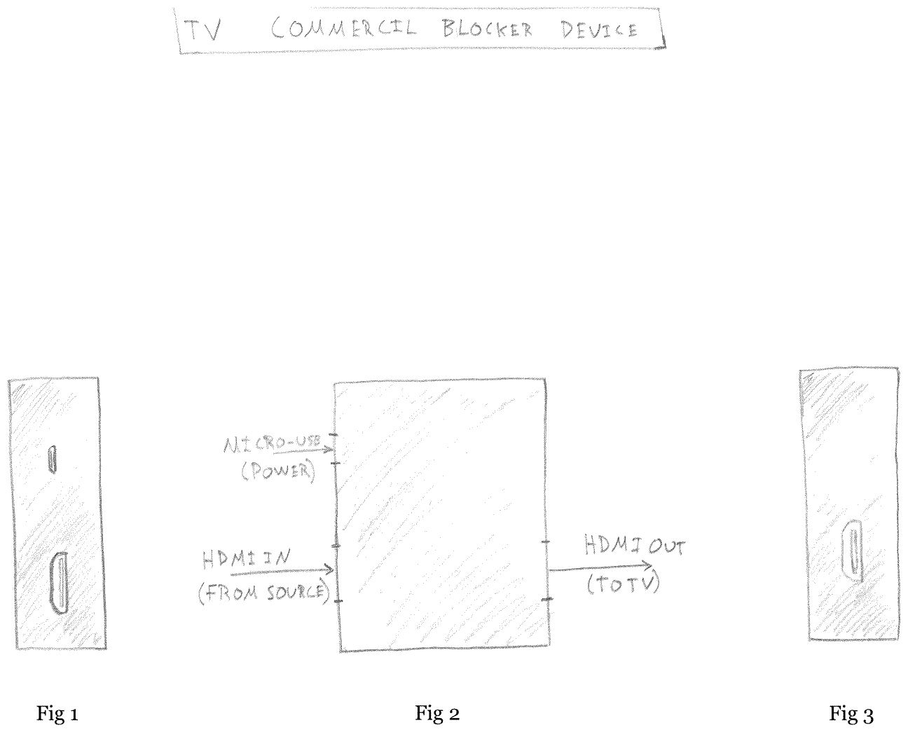

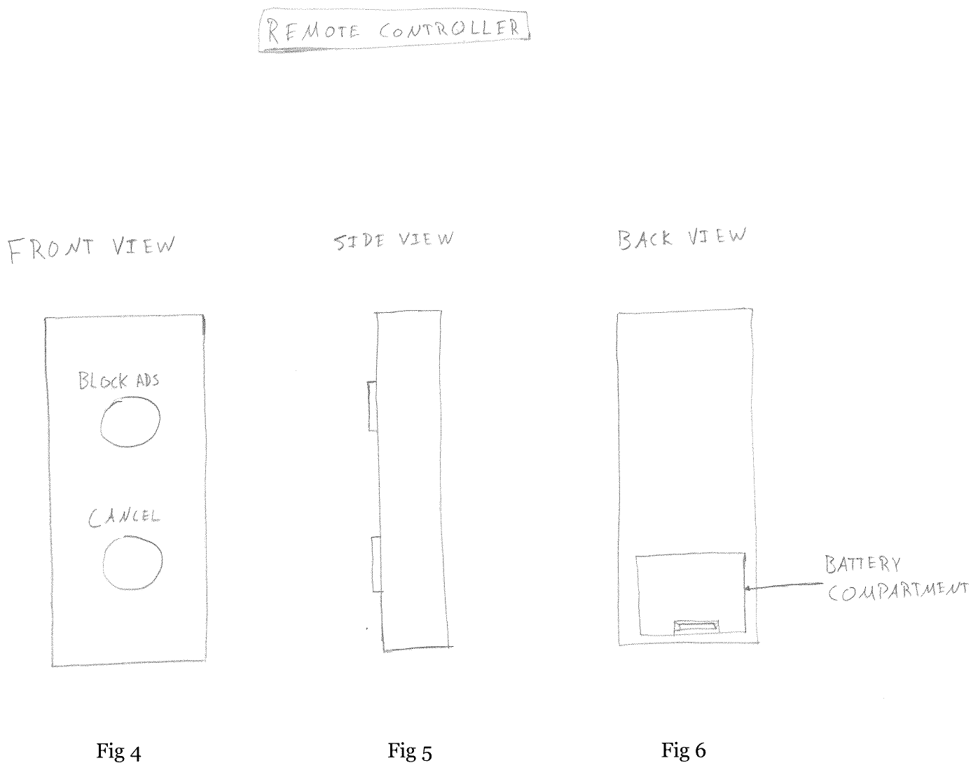

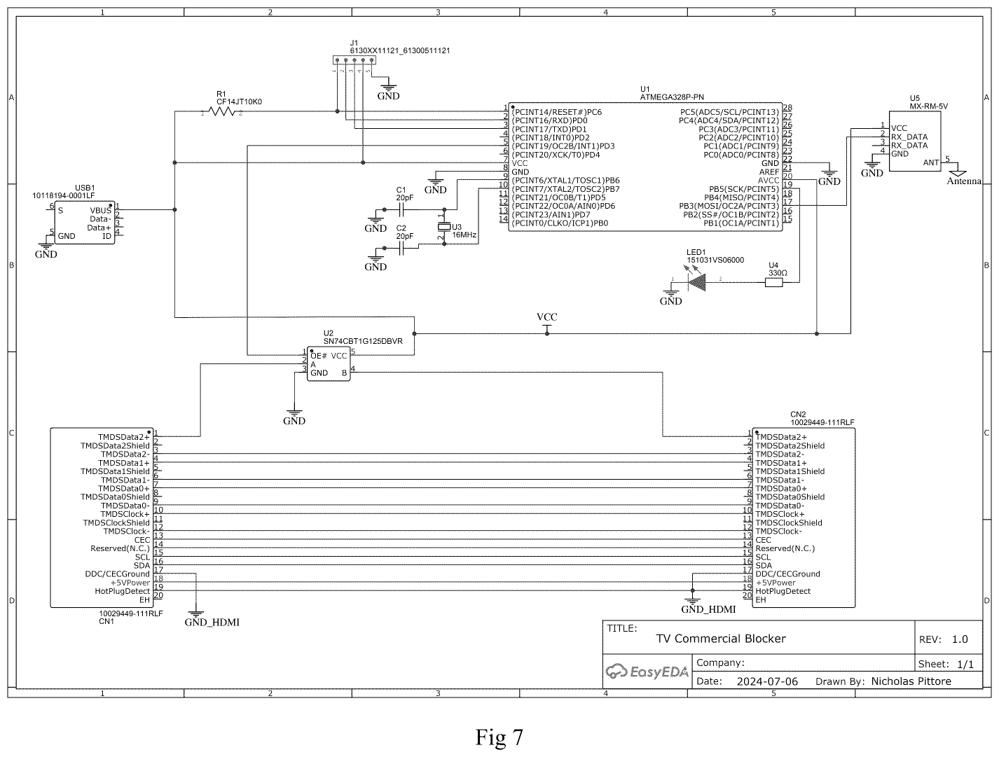

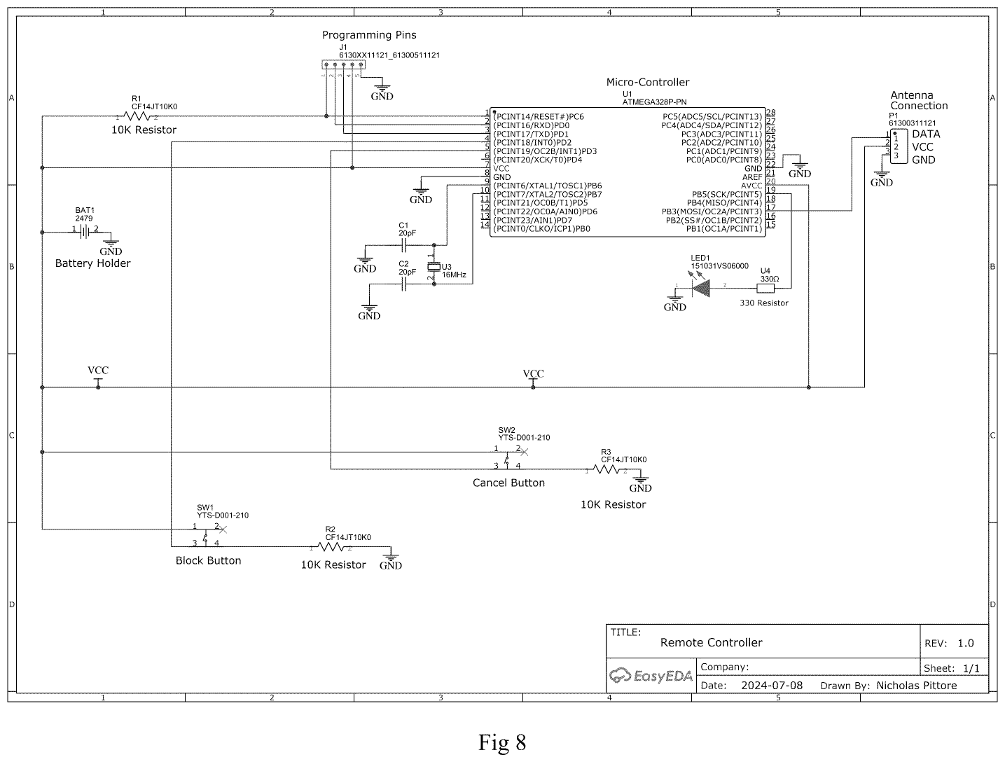

### DETAILED DESCRIPTION OF THE INVENTION

This invention will allow the user to block television commercials whenever they desire. To accomplish this, the Commercial Blocker device will have the following main components. A microcontroller circuit, an IR (infrared) receiver, a bus switch IC, which blocks or passes an electrical connection, two HDMI ports, a micro-usb port to be optionally used for power, and an outer enclosure. It will also have some other small components such as resistors and capacitors to make the previous components work properly.

The Commercial blocker device will block the television signal, when it gets the appropriate infrared signal from the user operated remote. The IR receiver component will receive this signal from the user remote and it will be passed to the microcontroller. The microcontroller will then block the television HDMI signal by triggering the bus switch to disconnect the HDMI signal pins between the input and the output ports, which results in the screen going blank and sound turning off. It will continue to block the signal for the set amount of time (slightly less than 120 seconds). Then, once the time has passed, it will resume transmitting by triggering the bus switch to connect the signal pins again, which causes the screen and sound to come back on. The microcontroller also runs the main program, which handles the delay, handles inputs and outputs, and also communicates with the user operated remote controller.

The device will be powered by the 5V pin of the HDMI cable, or optionally a micro-usb port (5V) that can be plugged into a USB port or wall outlet adapter.

The Remote Controller, which will be included with the commercial blocker product, will have a microcontroller circuit, an IR LED emitter to send IR signals, two input buttons, and an outer enclosure. The microcontroller will detect when the user presses the buttons and then pass the appropriate message to the onboard IR emitter to be sent to the commercial blocker device wirelessly. It will therefore allow the user to control the commercial blocker device to either initiate a commercial block period, and/or cancel it.

1. A device that allows the user to block television commercial breaks by pressing a button on a remote controller. The device accomplishes this by temporarily not transmitting the electrical, audio-visual signal to the television for a duration of time that corresponds to the length of a standard television commercial break, and then continuing to transmit the audio-visual signal after this time has elapsed.
